(19) United States
(12) Patent Application Publication
(10) Pub. No.: US 2017/0257007 A1
(43) Pub. Date: Sep. 7, 2017

(54) GENERATOR FOR A POWER PLANT

(71) Applicant: Siemens Aktiengesellschaft, Munich (DE)

(72) Inventors: Jan-Henrik Braam, Kalkar (DE); Christoph Evers, Bottrop (DE); Simon Gertz, Düsseldorf (DE); Esteban Grau Sorarrain, Düsseldorf (DE); Oliver Haberer, Dortmund (DE); Markus Hagedorn, Bochum (DE); Christian Jäkel, Duisburg (DE); Mario Koebe, Mülheim an der Ruhr (DE); Matthias Kowalski, Mülheim an der Ruhr (DE); Omer Mrkulic, Dinslaken (DE); Markus Mölders, Oberhausen (DE); Carolin Schild, Mülheim an der Ruhr (DE)

(73) Assignee: Siemens Aktiengesellschaft, Munich (DE)

(21) Appl. No.: 15/507,521

(22) PCT Filed: Aug. 27, 2015
(86) PCT No.: PCT/EP2015/069606

§ 371 Date: Feb. 28, 2017

(30) Foreign Application Priority Data
Sep. 8, 2014 (EP) 14183928.2

(51) Int. Cl. H02K 9/06; H02K 3/24; H02K 1/20; H02K 7/18

(52) U.S. Cl. CPC H02K 9/06; H02K 7/1807; H02K 3/24; H02K 1/20; F04D 19/002

(57) ABSTRACT

A generator for a power plant and a method for cooling the generator, where the generator includes a stator and a rotor, the stator carrying conductors. The conductors for a winding overhang at least at one end of the stator and the generator has a fan for cooling the winding overhang. The fan produces a cooling air flow directed onto the winding overhang and has an axial component and a radial component.

### CROSS REFERENCE TO RELATED APPLICATIONS

This application is the US National Stage of International Application No. PCT/EP2015/069606 filed Aug. 27, 2015, and claims the benefit thereof. The International Application claims the benefit of European Application No. EP14183928 filed Sep. 8, 2014. All of the applications are incorporated by reference herein in their entirety.

### FIELD OF INVENTION

The present invention relates to a generator for a power plant, and to a method for cooling the generator.

### BACKGROUND OF INVENTION

In turbo generators, the individual bars of the stator are connected by means of a so-called end winding. In the end winding, the bars are guided in both the tangential and the radial directions such that at the end of the end winding the bars that are to be connected lie next to one another. These bars must be electrically connected to one another, it being possible to effect the connection in various ways. One option is to connect the individual subconductors of one bar to the subconductors of a second bar, which is termed subconductor interconnection. Another option is to gather the subconductors of one bar into bundles, and to connect these bundles to the respective bundles of the opposite bar, which is termed bundle connection. A third variant involves fully soldering the subconductors of one bar to one another, and effecting the connection to the opposite bar in solid fashion using a bracket. All connection types share the fact that the connections must be established manually and insulation must be applied thereafter. The use of brackets gives rise to additional resistance losses, which lead to heating of the end winding. The increased temperatures further increase the electrical resistance and thus further reduce the efficiency of the generator.

In many turbo generators, the bracket connection at the end winding is the performance-limiting component. This limiting effect is due to the brackets heating up because of the electrical resistance.

Hitherto, the bracket connection was effected with a minimum insulation thickness in order to provide good indirect external cooling. However, thin insulation is possible only in the case of adjacent brackets with a low voltage difference. At phase transition points, thick insulation is applied.

In addition, the stator end winding, inter alia, is cooled by a ventilator on the rotor. In that context, the ventilator blades are arranged radially with respect to a central axis of the rotor and generate an axial air stream which cools the stator end winding among other things.

EP 0 643 465 A1 describes an air-cooled rotating electrical machine. JP S53 115304 U describes a machine having an end winding. JP S58 145066 U describes a machine having an end winding.

### SUMMARY OF INVENTION

The invention has an objective of providing a generator having improved cooling and higher efficiency associated therewith.

The generator according to the invention has the advantage, over the generators known from the prior art, that the fan generates a cooling air stream which reduces the thermal load on the bracket connections or on the stator end winding, in that the heat is removed more efficiently by means of a cooling air stream with a radial and an axial component. By virtue of the improved cooling of the end winding, generators of the same size can be more efficient and/or more powerful.

Advantageous refinements of and improvements to the generator indicated in the independent claim are made possible by the measures set out in the dependent claims.

According to the invention, the fan has a first region, which generates a cooling air stream oriented axially with respect to a central axis of the rotor, and has a second region, which generates a cooling air stream oriented radially or diagonally with respect to the central axis of the rotor. By virtue of this solution, the cooling air stream in the axial direction is retained and is complemented by an additional cooling air stream in the radial and/or diagonal direction, thus making it possible to achieve an optimized flow onto the end winding and an associated improved removal of heat.

In that context, it is particularly advantageous if the first region is designed concentrically about the central axis of the rotor, and the second region encloses the first region at least in certain sections, advantageously concentrically. By virtue of this solution, it is possible to achieve broader subdivision of the cooling air stream without additional guide vanes, thus enabling a structurally simple and cost-effective embodiment of the generator.

One embodiment variant has a fan with at least one fan blade, wherein this fan blade has a first section which runs radially with respect to a central axis of the rotor, and has a second section which runs at an angle of 10° to 90° with respect to the central axis of the rotor. A fan blade of this type generates, in its first section, an axial cooling air stream and, in its second section, a cooling air stream which is formed radially or diagonally with respect to the axial cooling air stream. It is particularly expedient if the second section is formed at an angle of 30° to 75° with respect to the central axis of the rotor, since in this manner the second region generates an expedient cooling air stream running diagonally with respect to the central axis.

In that context, it is especially advantageous if the second section adjoins, in the radial direction from the central axis of the rotor, the outside of the first section of the fan blade. Thus, the first region generates an essentially axial cooling air stream on the inside, while the second region generates a diagonal cooling air stream. It is thus possible, using one fan or one fan blade, to generate a cooling air stream with a radial and/or diagonal component and an axial component.

One advantageous refinement is that the fan blade is of L-shaped design. This produces a radially oriented cooling air flow at that end of the fan blade that is remote from the central axis, while an axial flow is formed at that end of the cooling air blade which is oriented toward the central axis.

One advantageous refinement is that the fan blade tapers in the direction from the central axis of the rotor to its end region oriented away from the rotor. This makes it possible to keep the moved masses low and to save material on the fan blade.

Alternatively, there is provided an embodiment in which the fan has a first impeller for generating an air stream axially with respect to a central axis of the rotor, and a second impeller for generating an air stream radially or diagonally with respect to the central axis of the rotor. A fan having an axial ventilator and a radial ventilator also makes it possible, in a simple and cost-effective manner, to generate a cooling air stream which, in addition to an axial component, also has a radial and/or diagonal component.

In that context, it is particularly advantageous if the second impeller is of annular design, wherein the first impeller and the second impeller are arranged concentrically with respect to one another. This makes it possible to achieve simple positioning and securing of the impellers with respect to one another, wherein the first impeller is arranged inside the annular second impeller.

In that context, it is particularly advantageous if there is formed, on the fan, a ring which outwardly bounds the first, inner impeller and inwardly bounds the second impeller. It is thus possible for the first impeller and the second impeller to be easily mounted in a common housing or prefabricated as a subassembly, which reduces installation expenditure.

In this application, the terms radial and diagonal are to be understood not only as angles of 90° or, respectively, 45° with respect to the central axis of the rotor, but as an angular range from 5° to approximately 100°, and serve to delimit a flow axially with respect to the central axis of the rotor, which is formed essentially at an angle of approximately 0°, that is to say parallel to the central axis.

### BRIEF DESCRIPTION OF THE DRAWINGS

An exemplary embodiment of the generator according to the invention will be explained below with reference to the appended drawings. In that context, identical components or components having identical functions are labeled with identical reference signs.

FIG. 1 shows a section through a generator according to the invention.

FIG. 2 shows a detail from the generator, illustrating a rotor with a fan blade and a baffle.

FIG. 3 shows a fan blade of a generator according to the invention.

FIG. 4 is a 3-D view of the drive shaft of the rotor with fan blades according to the invention.

FIG. 5 is a front view of a combined radial/axial ventilator of a generator according to the invention.

FIG. 6 is a side view of the combined radial/axial ventilator.

### DETAILED DESCRIPTION OF INVENTION

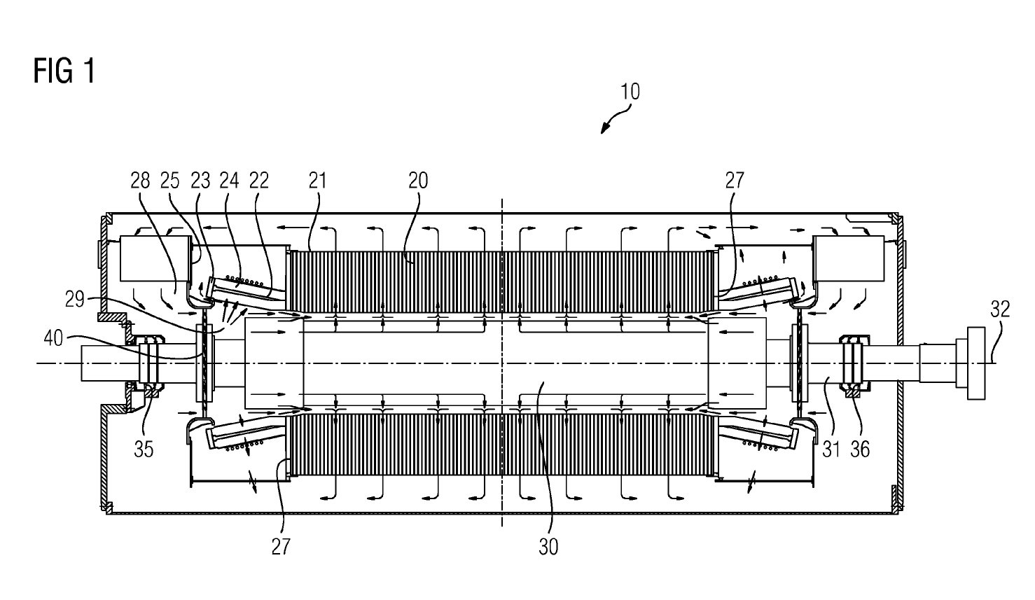

FIG. 1 shows a generator 10 for a power plant. The generator has a stator 20 in which there is arranged a rotor 30. The rotor 30 has a drive shaft 31 which is rotatably mounted at two bearings 35, 36. A central axis 32 runs through the drive shaft 31 of the rotor 30. The stator 20 is shielded on both sides by dividers 25. The stator 20 has a stator body 21 from which current conductors 22 exit at the ends 27 and form an end winding 24. In order to connect the current conductors 22, brackets 23 are provided at the ends and connect two adjacent current conductors 22 to one another in the end winding 24.

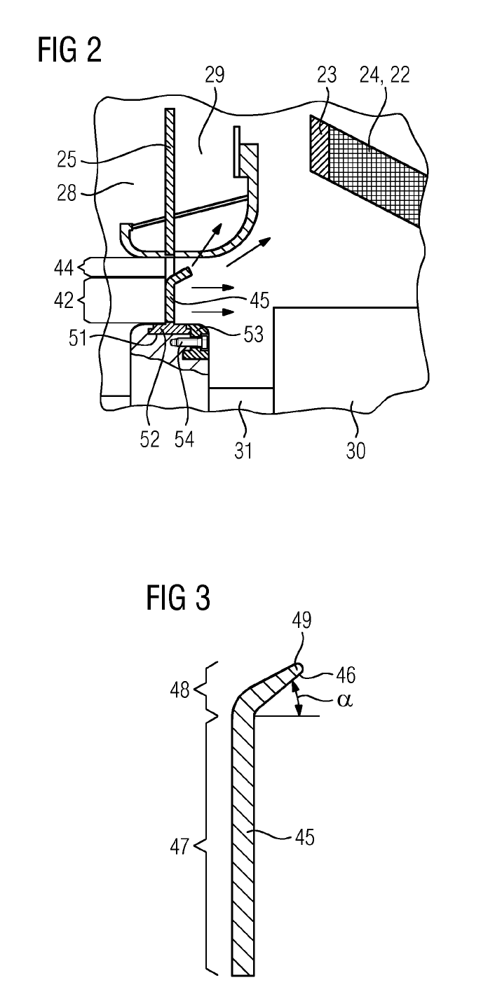

A fan 40 is attached to the rotor 30 and has, in the simple embodiment shown, fan blades 45 which are attached to the drive shaft 31 of the rotor, as shown in FIG. 2. The fan blades 45 are distributed evenly over the circumference of the drive shaft 31 and run in a plane with the divider 25 which laterally bounds the stator 20 and separates a suction side 28 of the fan 40 from a pressure side 29 of the fan 40. The fan blade 45 has a blade root 52 which can be secured in a slot 51 of the drive shaft 31. To that end, a clamping element 53 is provided on the drive shaft 31 and can be secured to the drive shaft 31 by means of a screw 54, and thus securely fixes the blade root 52 of the fan blade 45. The fan blade 45 has a first region 42 which runs radially or perpendicular with respect to the central axis 32 of the rotor 30 or of the drive shaft 31. The first region 42 is designed to generate a cooling air flow which runs axially with respect to the central axis 32 of the rotor 30. Adjoining this in the radially outward direction is a second region 44 which concentrically encloses the first region 42. The second region 44 is designed to create a cooling air flow at an angle of 5° to approximately 100° with respect to the central axis of the rotor, which flow is hereinafter termed radial or diagonal cooling air flow.

FIG. 3 shows the fan blade 45. The fan blade 45 has a first section 47 which runs radially with respect to the central axis 32 of the rotor 30, a second section 48 adjoining this in the radially outward direction and running at an angle α of approximately 30° with respect to the central axis 32 of the rotor 30. Alternatively, other angles a between approximately 5° and approximately 85°, advantageously between 30° and 60°, are also conceivable. As the drive shaft 31 of the rotor 30 rotates, the first section 47 generates the first, axially oriented region 42 of the cooling air flow, while the second section 48 of the fan blade 45 generates the second, diagonal or radial region 44 of the cooling air flow.

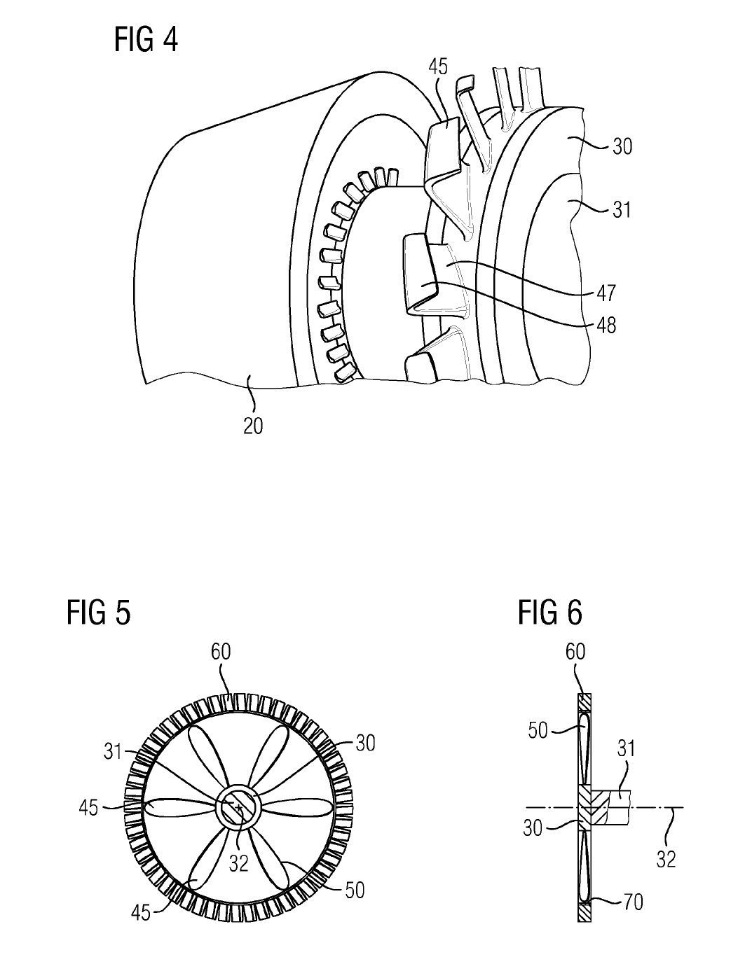

The fan blade 45 has, at an end 49 oriented away from the drive spindle 31, a taper 46 in order to reduce pressure fluctuations at the end 49 of the fan blade 45, and in order to concentrate the moved masses as close as possible to the rotor 31. FIG. 4 again shows the combination of drive shaft and fan, in a perspective view.

FIG. 5 shows an alternative embodiment of the fan 40. A first impeller 50 is arranged on the drive shaft 31 of the rotor 30 in order to generate a cooling air stream in the axial direction, parallel to the central axis 32 of the rotor 30. The first impeller 50 is outwardly bounded by a ring 70, the ring 70 simultaneously forming an outer diameter of the first impeller 50 and an inner diameter of a second impeller 60, which is formed in annular fashion around the first impeller 50 and establishes a cooling air stream radially or diagonally with respect to the central axis 32 of the rotor 30. In so doing, the ring 70 separates the axial cooling air stream of the first impeller 50, which is designed as an axial ventilator, from the cooling air stream of the second impeller 60, which is designed as a radial ventilator. FIG. 6 additionally shows the ventilator from FIG. 5 in a side view.

When the generator 10 is in operation, the drive shaft 31 of the rotor 30 rotates. In the process, air is drawn in by the fan 40 on the suction side 28 of the divider 25 and is delivered to the pressure side 29. In that context, the air flow is indicated by the small arrows in FIG. 1. The air flows in the axial direction through openings in the end 27 of the stator 20 into the generator 10 or between the drive shaft 31 of the rotor 30 and the stator body 21, and flows back again on the outer side of the stator 20. The solution according to the invention achieves a markedly better, direct flow of cooling air onto the end windings 24, and therefore realizes better cooling of the end winding 24.

In the case of a closed cooling system, another coolant can also be used instead of air.

1.-10. (canceled)

11. A generator for a power plant, comprising:
a stator and a rotor, wherein the stator guides current conductors, and wherein the conductors form an end winding at at least one end of the stator, and
a fan for cooling the end winding, wherein the fan generates a cooling air flow directed at the end winding, with an axial component and a radial component,
wherein the fan has a first region, which generates a cooling air stream oriented axially with respect to a central axis of the rotor, and has a second region, which generates a cooling air stream oriented radially or diagonally with respect to the central axis of the rotor,
wherein the fan has at least one fan blade, wherein the at least one fan blade has a first section which runs radially with respect to a central axis of the rotor, and has a second section which runs at an angle of 5° to 85°, preferably between 30° and 60°, with respect to the central axis of the rotor.

12. The generator as claimed in claim 11,
wherein the first region is designed concentrically about the central axis of the rotor, and the second region encloses the first region.

13. A generator for a power plant, comprising:
a stator and a rotor, wherein the stator guides conductors, and wherein the conductors form an end winding at at least one end of the stator, and
a fan for cooling the end winding, wherein the fan generates a cooling air flow directed at the end winding, with an axial component and a radial component,
wherein the fan has a first region, which generates a cooling air stream oriented axially with respect to a central axis of the rotor, and has a second region, which generates a cooling air stream oriented radially or diagonally with respect to the central axis of the rotor,
wherein the fan has a first impeller for generating an air stream axially with respect to a central axis of the rotor, and a second impeller for generating an air stream radially or diagonally with respect to the central axis of the rotor.

14. The generator as claimed in claim 13,
wherein the first region is designed concentrically about the central axis of the rotor, and the second region encloses the first region.

15. The generator as claimed in claim 11,
wherein the second section adjoins, radially in relation to the central axis of the rotor, the outside of the first section of the fan blade.

16. The generator as claimed in claim 11,
wherein the at least one fan blade is of L-shaped design.

17. The generator as claimed in claim 11,
wherein the at least one fan blade tapers in the direction from the central axis of the rotor to its end region oriented away from the rotor.

18. The generator as claimed in claim 13,
wherein the second impeller is of annular design,
wherein the first impeller and the second impeller are arranged concentrically with respect to one another, and
wherein the first impeller generates the air stream axially with respect to the central axis and the second impeller generates the air stream radially or diagonally with respect to the central axis.

19. The generator as claimed in claim 18,
wherein a ring is formed on the fan in order to bound the first impeller,
wherein the ring is arranged on an outer diameter of the first impeller in order to bound the first impeller, forms an inner diameter of the second impeller and separates the axial air stream from the radial or diagonal air stream.

20. A method for cooling a generator with a stator and a rotor, wherein conductors are guided in the stator, wherein the conductors form an end winding at at least one end of the stator, and wherein the generator has a fan for cooling the end winding, the method comprising:
generating a cooling air stream by the fan,
wherein the end winding is cooled by a cooling air flow directed thereat and having an axial component and a radial component, wherein the fan has a first region, which generates a cooling air stream oriented axially with respect to a central axis of the rotor, and has a second region, which generates a cooling air stream oriented radially or diagonally with respect to the central axis of the rotor,
wherein the fan has at least one fan blade,
wherein the at least one fan blade has a first section which runs radially with respect to a central axis of the rotor, and has a second section which runs at an angle of 5° to 85° with respect to the central axis of the rotor, or
wherein the fan has a first impeller for generating an air stream axially with respect to a central axis of the rotor, and a second impeller for generating an air stream radially or diagonally with respect to the central axis of the rotor.

21. The generator as claimed in claim 12,
wherein the first region is designed concentrically about the central axis of the rotor, and the second region encloses the first region concentrically.

22. The generator as claimed in claim 14,
wherein the first region is designed concentrically about the central axis of the rotor, and the second region encloses the first region concentrically.

20. The method as claimed in claim 20,
wherein the second section runs at an angle of between 30° and 60° with respect to the central axis of the rotor.
